(19) United States
(12) Patent Application Publication
(10) Pub. No.: US 2019/0389116 A1
(43) Pub. Date: Dec. 26, 2019

(54) EXTRUSION BLOW-MOLDED CONTAINER AND METHOD AND BLOW MOLD FOR THE PRODUCTION THEREOF

(71) Applicant: ALPLA WERKE ALWIN LEHNER GMBH & CO. KG, Hard (AT)

(72) Inventors: Christoph Nigl, Wolfurt (AT); Michael Marent, Hard (AT); Oswald Valtiner, Bregenz (AT); Christian Starchl, Dornbirn (AT)

(21) Appl. No.: 16/335,883

(22) PCT Filed: Sep. 22, 2017
(86) PCT No.: PCT/EP2017/074136

§ 371 Date: Mar. 22, 2019

(30) Foreign Application Priority Data
Sep. 22, 2016 (CH) 01238/16

(51) Int. Cl. B29C 49/04; B65D 1/02

(52) U.S. Cl. CPC B29C 49/04; B29K 2067/003; B65D 1/02

(57) ABSTRACT

The invention relates to an extrusion blow-molded container, the inside of which is defined by a container side wall and a container bottom, a standing area being detachably connected to the container side wall and to the container bottom. According to the invention, at least a subarea of a bottom of a primary container product formed from the parison is irreversibly moved into the container such that an undercut container bottom is embodied on the container at least in a subarea, the standing area of the container being formed in the region of the undercut container bottom from a side wall of the primary container product by bending and/or pressing down.

### CROSS-REFERENCE TO RELATED APPLICATIONS

This application is a national phase entry under 35 U.S.C. § 371 of PCT/EP2017/074136 filed Sep. 22, 2017, which claims priority to Swiss Patent Application No. 01238/16 filed Sep. 22, 2016, the entirety of each of which is incorporated by this reference.

### TECHNICAL FIELD

The invention relates to a container with a specially configured standing area, a method for the production of such a container, and a blow mold for the production of said container.

### PRIOR ART

At present, extrusion blow-molded containers made of plastic are used on a large scale for the packaging of fluid products, such as beverages, cleaning products, oils, cosmetics, etc. Their production generally involves the following steps: from a blowing head, a preform of plastic (such as polyethylene or polypropylene) is extruded, usually in the shape of a tube. The preform is introduced into an opened blow mold with a shaping cavity, consisting of two mold halves. After placing the preform between the halves of the opened blow mold, the halves are closed, the preform being clamped at its two open sides by the blow mold and closed on one side. At the other opposite side there remains an opening in the tube for introducing the blowing mandrel. By introducing a gas, especially air, into the interior of the preform by means of a blowing mandrel inserted into the opening and/or the inside of the blow mold, the gas is blown into the blow mold. The preform is inflated until it makes contact with the cooled wall of the cavity, whose shape it then assumes, thereby creating a container which can be stripped off by opening the mold. The extrusion blowing machines used in such methods usually possess one or more extruders for the supply of the plastic material. The exit of an extruder is connected to a respective blowing head, at the exit nozzle of which, being adjustable in its opening width, the preform emerges, being extruded in a single or multiple layers. The single or multiple-layered preform may be provided with viewing strips, decorative strips, or multiple segments, such as segments of different colors, around its periphery.

Thanks to the blowing process, the material of the preform is stretched and thereby reduced in its wall thickness. Moreover, material may only be removed from the preform in the regions where they are still in a pastelike state, i.e., not yet hardened by dwelling on the cooled wall of the cavity. When blow-molding the standing area from container bottom to the container side wall, portions of the container bottom and the container side wall have generally already been formed and hardened, so that little material of the preform remains to form this standing area. Consequently, the slight material needs to be further stretched, resulting in a thinning out of the wall thickness in this standing area. This effect is especially evident during the blow molding of the standing area that runs substantially transversely to the clamping of the preform, since the material is the most stretched here. Hence, there are limits to the shaping of the container bottom and thus the shape of the container. Yet the standing area needs to be particularly stable in shape so that a filled container when dropped from a height of at least 0.5 m does not break.

### THE PROBLEM OF THE INVENTION

Thus, one problem which the invention proposes to solve is to provide an extrusion blow-molded container whose standing area is sufficiently stable in shape regardless of the shape of the container bottom.

Benefits of the present invention will emerge from the following description.

### SUMMARY OF THE INVENTION

The above mentioned problem is solved by a container, a method and a blow mold as set forth herein.

In the following, features shall be described. The features are disclosed separately (as part of any given container, any given blow mold or any given method for production of a container) and—as long as they are not mutually exclusive—in any given combination. This includes the possibility of using device features for the specification of method features, and vice versa.

According to a first exemplary embodiment of the invention, an extrusion blow-molded container is proposed, the inside of which is defined by a container side wall and a container bottom, wherein a standing area is inseparably connected to the container side wall and to the container bottom. At least a partial region of a bottom of a container precursor formed from a preform is irreversibly moved into the container such that an undercut container bottom is formed on the container at least in a partial region. The standing area of the container is formed in the region of the undercut container bottom from a side wall of the container precursor by bending and/or upsetting.

An undercut container bottom in the sense of the invention cannot be stripped without damage from a cavity of a blow mold. As a rule, but not necessarily, the bottom of the container precursor is free of undercuts. The standing area is that region of the container touching a flat base when the container is stored properly in the upright position.

In order to make the proposed container, first of all a container precursor is blow-molded from a preform in a cavity of a blow mold, whose bottom region has been moved at least partly into the container by means of a movable slide by a displacement from a first position to a second position. The container precursor has taken on an outer shape corresponding to the inner shape of the cavity which the cavity assumes when the movable slide is standing at the first position. Thus, in broad measure the container precursor has been given the shape of the later container bottom, namely, insofar as it adjoins an end face of the movable slide generally facing the blowing mandrel, and also in broad measure the side wall of the later container. Moreover, the container precursor may also be given a container shoulder and a container neck with a pour opening of the later container. By a moving of the movable slide from the first position in which the shape of the bottom of the container precursor is defined to the second position in which the bottom of the container precursor is pushed or pressed into the container inside to create the container bottom of the container, the final shaping of the container bottom is achieved. Depending on the configuration of the slide, especially its shape in connection with a side wall of the cavity, and its stroke, a bending and/or an upsetting occurs for a partial region of the side wall of the container precursor adjacent to the bottom of the container precursor to form the container bottom of the later container, forming the standing area. Bending also includes folding, in which case the bending substantially forms a corner. During the bending or folding, the wall thickness of the side wall of the container precursor substantially remains the same. Thus, in the proposed container, a partial region of the side wall of the container precursor is formed into the standing area in the region of the undercut container bottom. By the use of a movable slide, the depth of the movement into the container interior to form the container bottom is not restricted. Neither is the configuration of the container bottom subject to any restriction. Hence, it is possible to create container bottoms which are outwardly bulging at the center, i.e., convex. Hence, a submerged pipe of a hand-operated pump of a spray bottle can terminate in the middle of the container bottom, for example, and thus make possible an improved emptying of the remaining product. The container bottom may also be formed as an inclined plane, so that the contents of the container collect at one container side wall. Because the standing area is not weakened during its forming in relation to the container side wall, additional material can be saved, since the container side wall can be thinner on the whole.

According to another exemplary embodiment of the invention, at least one partial region of a section of the container side wall adjoining the undercut container bottom is substantially perpendicular to a plane subtended by the standing area.

The section of the container side wall and the standing area form an apron. This apron stands substantially perpendicular to the plane and thus does not have a conical or a bell shape which might protrude beyond the remaining container side wall adjacent to the section. Hence, it can be assured that the container side wall extends smoothly from the shoulder to the standing area. The height of the apron is substantially the height by which the container bottom is moved irreversibly into the container.

According to another exemplary embodiment of the invention, the standing area has a thickness which is equal to or greater than a wall thickness of the container side wall.

A measurement of the thickness of the standing area may be done perpendicular to a first plane subtended by the standing area. A measurement of the thickness of the side wall is done substantially 1 mm to 2 mm above a second plane extending parallel to the first plane and intersecting the side wall, tangent to the highest point of the container bottom protruding into the container interior.

According to another exemplary embodiment of the invention, the container bottom and the container side wall make an angle which is equal to or less than 45°, equal to or less than 30° or equal to or less than 15°.

The more acute the angle, the greater the stability of the standing area. Since the angle is produced by bending, especially by folding, and/or by upsetting of the side wall of the container precursor, it is possible to produce a configuration of the standing area which can be substantially sharp-edged at its inner side. By substantially sharp-edged is meant that a radius of 0.2 mm at the inner side is permissible.

According to another exemplary embodiment of the invention, the side wall of the container precursor is folded to create the standing area of the container, forming an edge.

A folding in particular enables a substantially polygonal shape for the standing area. By folding in the sense of this invention is meant a substantially sharp-edged bending. The edge is able to further enhance the stability of the standing area. In particular, when the fold makes an angle of around 90°, forces acting on the standing area from the side, such as may occur when it is dropped, are well absorbed by the standing area and cushioned in the container side wall and/or the container bottom.

According to another exemplary embodiment of the invention, the container side wall and the container bottom extend parallel to each other in at least a partial region.

The container side wall and the container bottom may be spaced apart from each other or touch each other. Mutually touching surfaces prevent the container contents from getting into the standing area. Spaced apart surfaces, however, may have greater stability than touching surfaces. Especially as regards the emptying of remaining product from the container, it may be advantageous for the container contents to not get into the standing area.

According to another exemplary embodiment of the invention, the container side wall and the container bottom at least partly touch each other and/or are at least partly welded to each other in the partial region.

The welding process occurs in the blow mold without welding additives, solely due to the temperature and the pressure exerted by the slide and the inner wall of the cavity on the double wall. It should be pointed out that the slide is free of structures enlarging its circumference, such as a spreading mandrel. It is assumed that the thermal capacity of the plastic is enough to initiate a welding process when the walls touch its inner sides. The pressure exerted by the slide is therefore solely meant to bring and maintain the inner wall of the container bottom into contact with the inner wall of the container side wall. The quality of the welding can be improved by the exact positioning of the inner walls against each other. The standing area then has a thickness, measured substantially parallel to the plane subtended by the standing area, corresponding to substantially twice the wall thickness of the container side wall.

According to another exemplary embodiment of the invention, the standing area of the container tapers to a point.

By an upsetting or a folding and upsetting, it is possible to deform the standing area plastically. In this way, the standing area can be formed into a point, for example in order to make the standing area flush with the container side wall.

According to another exemplary embodiment of the invention, the standing area is encircling.

Thus, the container when properly stored upright creates a homogeneous appearance for the viewer, since the containers extends down to the surface on which it is placed.

According to another exemplary embodiment of the invention, the standing area is divided by at least two setbacks, which are spaced apart from each other.

The setbacks may be used to stiffen the container bottom, especially when situated opposite each other.

According to another exemplary embodiment of the invention, the standing area is divided by three setbacks, which are spaced apart from each other.

In this way, the standing area is substantially divided into three feet. In this way, it can be assured that the container will stand securely, or free of wobbling, even on uneven surfaces.

According to another exemplary embodiment of the invention, the container bottom bulges outward in convex manner and is set back from a plane subtended by the standing area.

For example, the submerged pipe of a hand-operated pump of a spray bottle may end at the center of the convex container bottom and thus improve the emptying of remaining product. The midpoint may also be formed as an upward pointing dome, so that in this way the emptying of remaining product can be even further improved. Of course, the dome may also be formed at another place of the container bottom.

According to another exemplary embodiment of the invention, a spacing of the container bottom from a plane subtended by the standing area substantially increases continuously from a first container side wall to a second container side wall standing opposite the first container side wall.

In this way, the container contents may collect at the first container side wall, so that in the case of a spray bottle for example the submerged pipe of a hand-operated pump can end at this first container side wall. This can bring about a better emptying of remaining product of the container. The container bottom is this case may be straight or curved concave or convex.

According to another exemplary embodiment of the invention, the container is made as a single piece of plastic.

The plastics used may be polyolefins such as HDPE, PP, PE, LDPE and their mixtures as well as polyamides and various polyester derivates such as PET-G, PET-X or recycled PET and their mixtures. Moreover, the preform may also comprise several layers of different plastics, for example in order to have color, sheen, and/or oxygen barriers.

According to another exemplary embodiment of the invention, a top side of the container standing opposite the container bottom has a shape corresponding to the container bottom and/or the top side of the container can be received in the container bottom of an identical container, so that several such containers can be stacked on top of each other.

The top side and the container bottom may be configured such that two identical containers stacked one on the other can be releasably joined together by form fit or friction locking.

According to another exemplary embodiment of the invention, a method is proposed for producing a container by means of extrusion blow molding, the inside of the container being defined by a container side wall and a container bottom, wherein a standing area is inseparably connected to the container side wall and to the container bottom, having the following steps of the method:
(i) introducing a preform into a cavity of an opened blow mold;
(ii) closing the blow mold and securing the preform in the cavity;
(iii) introducing gas under excess pressure into the preform, so that a wall of the preform is pressed against an inner wall of the cavity to create a container precursor with a bottom and a side wall;
(iv) displacing of a displaceable slide of the blow mold from a first position, in which the bottom of the container precursor was formed, to a second position, in which at least a partial region of the bottom is moved irreversibly into the container in such a way that an undercut container bottom is formed on the container at least in a partial region, the standing area of the container being formed in the region of the undercut container bottom from a side wall of the container precursor by bending and/or upsetting.

As a rule, air is used for the blow molding of the preform. Upon activating the slide, which may be designed as a punch, air with excess pressure may be situated in the container precursor, which is reduced in accordance with the stroke movement of the punch in order to have substantially a constant excess pressure inside the container until it is stripped from the mold. The excess pressure may also be dissipated from the container precursor prior to the movement of the slide. Of course, the punch will remain in the second position until such time as the container is ready to be stripped. Only then will the punch be moved from its second position toward the first position, until the slide is completely disengaged from the container being stripped, the blow mold is completely opened, and the container is removed.

According to another exemplary embodiment of the invention, the blow mold is closed during the moving of the slide from the first position to the second position.

According to another exemplary embodiment of the invention, the slide is free of structures enlarging its circumference, such as collapsible cores.

In this way, the slide can be designed as an especially easily produced and thus cost-effective punch.

According to another exemplary embodiment of the invention, the blow mold is opened for the movement of the slide from the first position by 1 mm, or 0.3 mm to 0.5 mm and it is closed after reaching the second position.

Instead of opening the entire blow mold, it is also possible to open only a partial region of the blow mold substantially bridging the height of the slide stroke by this amount. Especially if the side wall of the container precursor is to be folded substantially by 180°, an opening of the blow mold may have the effect of an easier everting of the partial region of the side wall which forms the standing area and a partial region of the container bottom. Also substantially no shear forces can act on the side wall during the movement of the slide by the slide in connection with the inner wall of the cavity. The closure can effectuate a compression of the parallel layers, so that a loop having formed in the region of the reversal or eversion of the side wall can be flattened. The compression may also result in an improved quality of the welding.

According to another exemplary embodiment of the invention, the moving of the slide from the first position to the second position folds a partial region of the side wall adjoining the bottom of the container precursor, creating an edge.

In addition, the region of the fold may be compressed by a suitable profiling of the slide, so that the standing area is likewise formed sharp-edged on its outer side, and a bending radius on the outside of the standing area is substantially unrecognizable.

According to another exemplary embodiment of the invention, a partial region of the container bottom extends substantially parallel to the container side wall.

The container side wall and the partial region of the container bottom may touch each other, be welded together, or be spaced apart from each other. Especially if they are touching and/or welded together, the container contents can be prevented from getting into the standing area.

According to another exemplary embodiment of the invention, the container side wall extending substantially parallel to the partial piece of the container bottom stands perpendicular to a plane subtended by the standing area.

The slide of the blow mold, as described above, can be moved from the first position to the second position. It may be provided that the slide has slide walls situated parallel to the direction of movement, while the bottom (or at least a partial region of the bottom) is displaced and/or shoved by means of the slide into the container interior such that a partial region of the container bottom and a partial region of the container side wall rest against each other and/or are at least partly welded together in the standing area of the container.

Said partial region of the container bottom and/or said partial region of the container side wall advantageously have the shape of a straight cylindrical casing or a straight prismatic casing and are oriented perpendicular to the plane subtended by the standing area. The plane subtended by the standing area advantageously contains the contact points of the container with a surface on which the container is placed in the upright position.

Alternatively or additionally, said partial region of the container bottom may run substantially parallel to said partial region, or section, of the container side wall and/or parallel to the portion of the container side wall adjoining said partial region.

According to another exemplary embodiment of the invention, the standing area of the container subtends a plane, wherein the lowest point of the container bottom of the container precursor is pushed by means of the slide so far into the container that the lowest point is set back into the container as compared to the plane.

In this way, the container bottom does not come into contact with the surface on which the container is properly placed.

According to another exemplary embodiment of the invention, a blow mold with a molding cavity is proposed to produce a container by means of extrusion blow molding, the inside of the container being defined by a container side wall and a container bottom, wherein a standing area is inseparably connected to the container side wall and to the container bottom. A slide displaceable from a first position into the cavity into a second position, and vice versa, defines in the first position a shape of a bottom of a container precursor and in the second position a shape of an undercut container bottom of the finished container.

The slide in this case can be moved substantially along the direction of extension of the cavity. The moving of the slide can be done mechanically, electrically, pneumatically or hydraulically. Thanks to a movement of the slide, the blow mold can have a cavity of variable shape. In the first position, the inner wall of the cavity defines the outer shape of the container precursor. In the second position, the inner wall of the cavity defines the outer shape of the container. A side wall of the slide may be set back from an inner wall of the cavity so far that substantially a double wall thickness of a side wall of a container being produced in the cavity is accommodated in this setback.

According to another exemplary embodiment of the invention, the end face of the movable slide is concave in shape, while in the first position only the end face of the slide defines the shape of the bottom of the container precursor and in the second position the end face together with an adjoining substantially cylindrical side wall of the slide defines the shape of the undercut container bottom of the container.

Of course, the end face of the slide may also have other shapes, such as convex or an inclined plane. Different shapes may also be combined with each other.

According to another exemplary embodiment of the invention, the slide of the blow mold is spaced away from an inner wall of the cavity such that at least a partial region of a side wall of the container precursor is bendable, especially foldable, and/or upsettable during movement of the slide from the first to the second position.

This partial region of the side wall, which is bent, folded and/or upset, forms the standing area on the finished container.

According to another exemplary embodiment of the invention, the slide is arranged on a first part of a movement distance between the first position and the second position at a greater lateral spacing from the inside of the cavity than on a second part of the distance.

The blow mold may have an annular encircling indentation. This indentation facilitates the reversal or everting of the partial region of the side wall of the container precursor, which forms the standing area of the later container. In this way, it may be easier for the partial region of the side wall of the container precursor to form a loop during the everting of this partial region to create the standing area of the later container. To assist the process, it may be provided that the bottom of the precursor product is larger circumferentially than the container bottom of the later container. The height of the annular indentation will generally be equal to or less than half the stroke of the punch.

### BRIEF DESCRIPTION OF THE DRAWINGS

There are shown in schematic representation, not true to scale:

FIG. 1a a container in perspective view from above;

FIG. 1b the container of FIG. 1a in perspective view from below;

FIG. 2a a side view of two containers stacked on one another;

FIG. 2b a side view of a container with submerged pipe;

FIG. 2c a side view of a container with additional product;

FIG. 2d a side view of a container with a hand-operated pump and submerged pipe as well as a bottom dropping off toward the edge;

FIG. 3a a longitudinal section through a blow mold with a movable slide in a first position; and

FIG. 3b the blow mold of FIG. 3a with a movable slide in a second position.

### DETAILED DESCRIPTION OF EXEMPLARY EMBODIMENTS

The invention shall now be explained as an example with the aid of the drawings.

FIG. 1a and 1b show a container 11 with a container side wall 31 and a container bottom 21, the material of the container side wall 31 passing smoothly and without interruption into the material of the container bottom 21. The transition has the shape of an edge 29. The edge was created by folding of a side wall of a container precursor and it forms the standing area of the container 11. The edge 29 extends along the entire circumference of the container bottom 21 and subtends a plane by which the container 11 can be placed in stable position standing on the edge.

Basically, it is also possible alternatively or additionally to form two (a third placement point could then form the edge), three or more standing feet along the margin of the container 11, especially along the edge 29, with the placement points of the standing feet (i.e., the points of contact with a surface) being situated in a plane.

In the present example, the container bottom 21 starts from the edge 29 and extends up to a distance of, for example, 1 to 2 centimeters from the edge 29 parallel to the container side wall 31 and it is advisedly welded to the latter. In this way, a double-wall region 30 of the container 11 is formed, which extends along the entire circumference of the container 11 and stiffens the lower region of the container 11. At least the double-wall region 30 is formed as a straight cylinder casing or a straight prismatic casing, which is substantially perpendicular to the plane subtended by the edge 29, at the same time forming the standing area. The container bottom 21 starting from the edge 29 extends parallel to the container side wall 31, then moves away from the container side wall 31 and extends in the direction toward a container longitudinal axis, while extending at the same time toward the plane defined by the edge 29 (i.e., downward), but without passing through said plane. In this way, the container bottom 21 has the shape of a shell, making it easier to empty remaining product from the container 11.

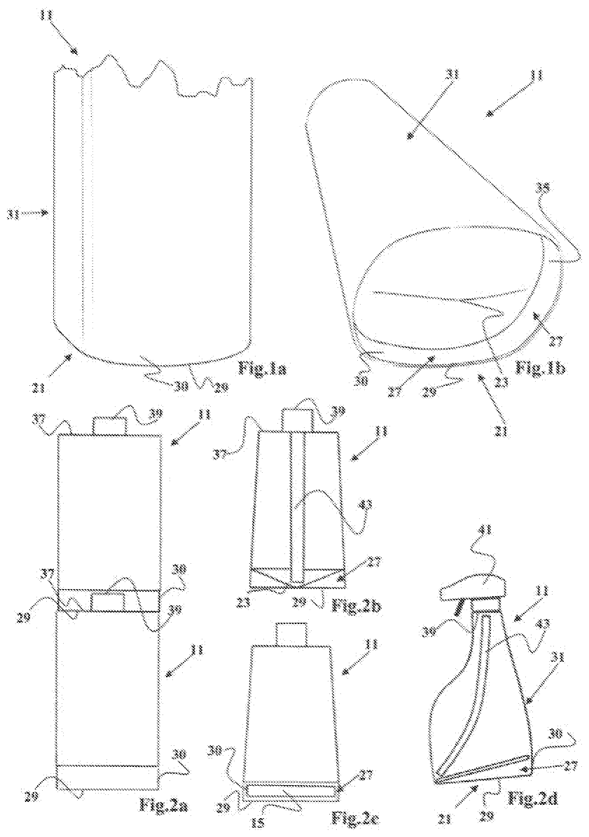

An alternative in which the container bottom 21 does not drop toward the standing area is shown in FIGS. 2a and 2c. Furthermore, the distance up to which the container bottom 21 extends starting from the edge 29 and parallel to the container side wall 31 may also be shorter on one side of the container 11 than on the opposite side and/or on the rest of the circumference. In particular, the distance from said point to the opposite side of the container 11 may increase. In this way, the lowest point of the inside of the container bottom 21 coming into contact with the product lies not in the middle of the container bottom 21, as shown in FIGS. 1b and 2b, but instead on one side of the container 11, as is shown for example in FIG. 2d. In containers 11 having a submerged pipe 43 to deliver the product from the container 11, such as the container shown for example in FIG. 2d with hand-operated dispensing or spray pump and a submerged pipe 43 connected to it, this may be advantageous for the emptying of remaining product.

The cavity 27 bounded by the double-wall region 30 on the underside of the container 11 affords room for an outwardly pointing indentation 23 of the container bottom 21 per FIG. 1b and 2b, but alternatively or additionally it may also serve to accommodate an additional product 15, such as a sponge, a pamphlet, or the like, as shown for example in FIG. 2c. The cavity 27 may also be formed alternatively or additionally to accommodate a top side of an identical container 11 and thereby make it possible to stack such containers, as illustrated in FIG. 2a. Advisedly, the top side of the container 11 will have a shape corresponding to the bottom side and/or to the container bottom 21 of the container 11. The bottom side and/or the container bottom 21 of a container 11 may accommodate for example the pour opening 39 and the region from the pour opening 39 to the shoulder 37 of the container 11, so that the edge 29 of the upper container 11 rests against the shoulder 37 of the lower container 11.

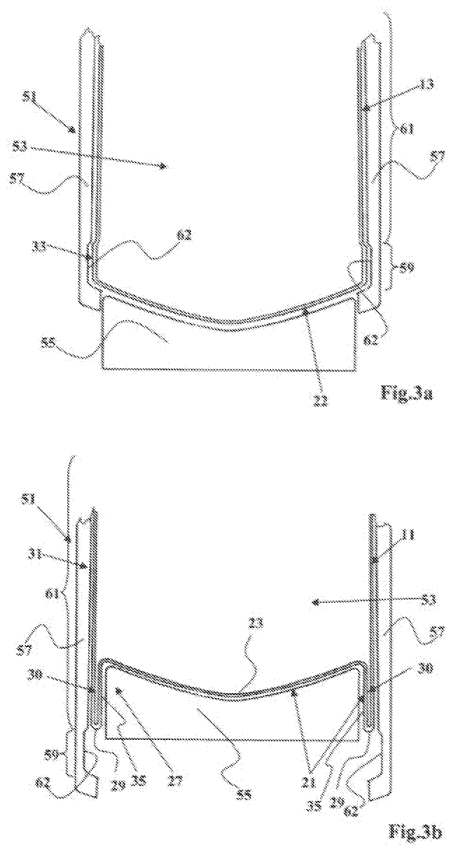

FIGS. 3a and 3b illustrate a portion of the method for making a container 11 per FIG. 1a and 1b. As is known, in extrusion blow molding a preform in the form of an extruded tube is first blow molded in a cavity 53 of a blow mold 51, whereupon the preform takes on the shape of the cavity 53 externally. This condition is shown in FIG. 3a, where the blow-molded preform after completion of the expansion of the preform produced by blowing a gas, especially air, into the cavity and/or at maximum extension of the preform is known as the container precursor 13. In addition, it should be pointed out that in a conventional extrusion blow molding, this container designated as the container precursor 13 represents the end product intended for stripping from the mold.

This container precursor 13, having a side wall 33 and a bottom 22, is deformed by introducing a slide 55 of the blow mold 51, able to move in the extension direction of the container precursor 13, into the cavity 53. The movable slide 55 is moved in this process from a first position, represented in FIG. 3a, to a second position, shown in FIG. 3b, while the blow mold 51 can remain closed during the process, but possibly also it is slightly open up to a maximum of 1 mm, or 0.3 mm to 0.5 mm. In the present exemplary embodiment, the parts 57 of the blow mold 51 defining the shape of the side wall 33 of the container precursor 13 are not moved and/or their position relative to each other is not changed (therefore being designated “nonmoving parts 57” in the following).

The end face of the movable slide 55 is concave and defines in the first position substantially the shape of the bottom 22 of the container precursor 13. The bottom 22 of the container precursor 13 extends in the first position of the movable slide 55 by at most 10 or 5 or at least 1 or 2 material thicknesses (especially thicknesses of the material of the side wall 33 of the container precursor 13) to the side beyond the movable slide 55. The nonmoving parts 57 for this purpose may have an indentation 62 in a first section 59 adjoining the movable slide 55 in the first position and extending along the entire circumference of the movable part 55. The first section 59 is bordered by a second section 61, which determines the shape of the finished container 11, being visible when the container 11 is stored on a flat surface. The average extension of the indentation 62 in the direction of movement (i.e., from the first position in the direction of the second position) of the movable slide 55 and/or in the direction of the longitudinal axis of the container precursor 13 can advantageously correspond to at least 20, 30 or 40 and/or at most 80, 70 or 60 percent of the distance traveled by the movable slide 55 between the first position and the second position.

If the movable slide 55 is moved from the first position into the cavity 53 in the second position, the bottom 22 of the container precursor 13 will be shoved into the interior of the container precursor 13 bounded by the side wall 33 and the bottom 22. The region of the side wall of the container precursor 13 adjoining the bottom 22 of the container precursor 13, being the partial region of the side wall 33 of the container precursor 13 situated in the indentation 62 in the first position of the movable slide 55, will be everted or reversed, become attached at the side to the movable slide 55, and finally form a partial region of the undercut container bottom 21 of the finished container 11. This portion of the container bottom 21 adjacent to the formed edge 29, which at the same time forms the standing area of the container 11, is oriented parallel to the partial region of the container side wall 31 of the container 11 bordering on the edge 29 and advisedly firmly joined to it by the action of heat. Hence, the edge 29, or the standing area of the container 11, is formed from a partial region of the side wall 33 of the container precursor 13. For the stripping of the container 11 from the mold, the movable slide 55 must be moved from its second position back to the first position far enough so that the movable slide 55 is disengaged from the container 11.

1. An extrusion blow-molded container, comprising:
a container having an inside defined by a container side wall and a container bottom, wherein a standing area is inseparably connected to the container side wall and to the container bottom, and
at least a partial region of a bottom of a container precursor formed from a preform irreversibly moved into the container such that an undercut container bottom formed on the container at least in a partial region, the standing area of the container being formed in the region of the undercut container bottom from a side wall of the container precursor by bending or upsetting.

2. The container as claimed in claim 1, wherein at least one partial region of a section of the container side wall adjoining the undercut container bottom is substantially perpendicular to a plane subtended by the standing area.

3. The container as claimed in claim 1, wherein the standing area has a thickness that is equal to or greater than a wall thickness of the container side wall.

4. The container as claimed in claim 1, wherein the container bottom and the container side wall make an angle that is equal to or less than 45°.

5. The container as claimed in claim 1, wherein the side wall of the container precursor is folded to create the standing area of the container, forming an edge.

6. The container as claimed in claim 1, wherein the container side wall and the container bottom extend parallel to each other in at least one other partial region.

7. The container as claimed in claim 6, wherein the container side wall and the container bottom at least partly touch each other or are at least partly welded to each other in the at least one other partial region.

8. The container as claimed in claim 1, wherein the standing area tapers to a point.

9. The container as claimed in claim 1, wherein the standing area is encircling.

10. The container as claimed in claim 1, wherein the standing area is divided by at least two setbacks that are spaced apart from each other.

11. The container as claimed in claim 1, wherein the container bottom bulges outward in a convex manner and is set back from a plane subtended by the standing area.

12. The container as claimed in claim 1, wherein a spacing of the container bottom from a plane subtended by the standing area substantially increases continuously from a first container side wall to a second container side wall standing opposite the first container side wall.

13. The container as claimed in claim 1, wherein the container is made as a single piece of plastic.

14. The container as claimed in claim 1, wherein a top side of the container standing opposite the container bottom has a shape corresponding to the container bottom or the top side of the container can be received in the container bottom of an identical container, so that a plurality of containers can be stacked on each other.

15. A method for producing a container by extrusion blow molding, an inside of the container being defined by a container side wall and a container bottom, wherein a standing area is inseparably connected to the container side wall and to the container bottom, comprising:
introducing a preform into a cavity of an opened blow mold;
closing the blow mold and securing the preform in the cavity;
introducing gas under pressure into the preform, so that a wall of the preform is pressed against an inner wall of the cavity to create a container precursor with a bottom and a side wall;
displacing of a displaceable slide of the blow mold from a first position, in which the bottom of the container precursor was formed, to a second position, in which at least a partial region of the bottom is moved irreversibly into the container in such a way that an undercut container bottom is formed on the container at least in a partial region, the standing area of the container being formed in the region of the undercut container bottom from a side wall of the container precursor by bending or upsetting.

16. The method as claimed in claim 15, further comprising closing the blow mold during the moving of the slide from the first position to the second position.

17. The method as claimed in claim 15, wherein the slide is free of structures enlarging its circumference.

18. The method as claimed in claim 15, further comprising opening the blow mold for the movement of the slide from the first position by 1 mm and closing the blow mold after reaching the second position.

19. The method as claimed in one of claim 15, wherein the moving of the slide from the first position to the second position folds a partial region of the side wall adjoining the bottom of the container precursor, creating an edge.

20. The method as claimed in one of claim 15, further comprising extending a partial region of the container bottom substantially parallel to the container side wall.

21. The method as claimed in claim 15, wherein the standing area of the container subtends a plane, wherein a lowest point of the container bottom of the container precursor is pushed by the slide so far into the container that the lowest point is set back into the container as compared to the plane.

22. A blow mold, comprising:
a molding cavity to produce a container by extrusion blow molding, an inside of the container being defined by a container side wall and a container bottom, wherein a standing area is inseparably connected to the container side wall and to the container bottom, and
a slide displaceable from a first position into the molding cavity into a second position, and vice versa, defines in the first position a shape of a bottom of a container precursor and in the second position a shape of an undercut container bottom of the finished container.

23. The blow mold as claimed in claim 22, wherein an end face of the movable slide is concave in shape, while in the first position only the end face of the slide defines the shape of the container bottom of the container precursor and in the second position the end face together with an adjoining substantially cylindrical side wall of the slide defines the shape of the undercut container bottom of the container.

24. The blow mold as claimed in claim 22, wherein the slide is spaced away from an inner wall of the molding cavity such that at least a partial region of a side wall of the container precursor is bendable, foldable, or upsettable during movement of the slide from the first position to the second position.

25. The blow mold as claimed in claim 24, wherein the slide is arranged on a first part of a movement distance between the first position and the second position at a greater lateral spacing from the inside of the molding cavity than on a second part of the movement distance.
